(19) United States
(12) Patent Application Publication
(10) Pub. No.: US 2020/0067895 A1
(43) Pub. Date: Feb. 27, 2020

(54) Contact Management System and Method

(71) Applicant: Ryan Deacon Adami, Avon, CO (US)

(72) Inventor: Ryan Deacon Adami, Avon, CO (US)

(21) Appl. No.: 16/112,851

(22) Filed: Aug. 27, 2018

(51) Int. Cl. H04L 29/06; G06F 21/62

(52) U.S. Cl. CPC H04L 63/0442; G06F 2221/2115; G06F 21/6245

(57) ABSTRACT

The present invention discloses a system and method for the secure exchange of information. The system includes a plurality of users including a primary user in communication with a primary device. The primary user in network communication with a plurality of third-party users each in communication with a third-party device, The primary device includes a storage component configured to store a plurality of information. The third-party device includes a second local storage configured to store the plurality of information. A first application system is stored on the primary device and while a second application system is stored on the third party device. The first application system is operable, via a first processor, to transmit a plurality of encrypted information to the third-party device. The second application system is operable, via a second processor, to receive and decrypt the encrypted information.

### TECHNICAL FIELD

The embodiments presented relate to the management of user contact information, and in particular, to the secure transfer and automatic distribution of updated contact information between users in a network while syncing the information to a device.

### BACKGROUND

Personal information is often stored on local and external databases in communication with a user's electronic device. In recent years, the advance in technology has led to an increase in the variety of contact information one may possess. Common contact information includes, but is not limited to phone numbers, legal name changes, email addresses, fax numbers, profile names, residences addresses, and business addresses. This information is often managed by a computer program or application on the user's electronic device system.

As individuals update their personal information (e.g., moves to a new address, changes employers, creates a new business, or receives a new phone number, etc.), the individual must convey the change to their contacts to communicate effectively. Contacts are often updated by sending updated information to each contact (e.g., sending an email, or placing a phone call, etc.) to notify contacts of the change in information. Contacts are then required to enter the change in information manually. Naturally, this lowers the fidelity of contact data as a result of user-error and adherence.

One solution to simplify this task utilizes a central profile service where registered users can send updated contact information to be stored in a central server. These services maintain links between registered users that consent to share contact information with one another. While useful, this requires sensitive personal information to be stored in a central location, which increases the risk of privacy issues due to security breaches. Often, personal information is stored on the servers, including user IP addresses which are made available if the security of the system is compromised.

Current information exchange systems fail to provide a means for limiting the information shared between users. This results in information updates being automatically shared between the community of users.

### SUMMARY OF THE INVENTION

This summary is provided to introduce a variety of concepts in a simplified form that is further disclosed in the detailed description of the invention. This summary is not intended to identify key or essential inventive concepts of the claimed subject matter, nor is it intended for determining the scope of the claimed subject matter.

In one aspect, the embodiments presented disclose a system for the secure exchange of information comprising a plurality of users including a primary user in communication with a primary device. The primary user is in network communication with third-party users each in communication with a third-party device. The primary device includes a local storage component configured to store a plurality of information, and the third-party device includes a second local storage configured to store a plurality of information. An application system is stored on the primary device and the third-party device such that the application system is operable, via at least one processor, to encrypt primary user information, transmit the encrypted primary user information to a remote database, transmit the encrypted information to the third-party users, and decrypt the encrypted information received by the third-party user. Decrypted information is stored on the second local storage component and removed from the remote database.

In one aspect, a method for the secure exchange of information comprises the following steps. First, each application system verifies a plurality of information provided on a local storage component in communication with the primary device. Next, the primary user updates information using the application system which identifies a plurality of third-party user identifications. Updated information is encrypted on the primary device and transmitted to a remote database. A notification is transmitted to the third-party users. The encrypted information is then removed from the remote database and decrypted via the third-party device such that the newly updated information can be stored thereon.

In one aspect, information is encrypted and decrypted using a public/private key unique to each of the plurality of users.

In another aspect, the remote database stores a hashed user identification for the primary user and the plurality of third-party users.

Moreover, in accordance with a preferred embodiment of the present invention, other aspects, advantages, and novel features of the present invention will become apparent from the following detailed description in conjunction with the drawings.

### BRIEF DESCRIPTION OF THE DRAWINGS

A more complete understanding of the present invention and the advantages and features thereof will be more readily understood by reference to the following detailed description when considered in conjunction with the accompanying drawings wherein:

FIG. 1A illustrates a block diagram of a user flow for the contact management system, according to some embodiments;

FIG. 1B illustrates a block diagram of the application system infrastructure, according to some embodiments;

FIG. 2 illustrates a flowchart of a method for securely sharing information within the contact management system, according to some embodiments;

FIG. 3A illustrates a flowchart of a method for connecting and inviting known or unknown users, according to some embodiments;

FIG. 3B illustrates a flowchart of a method for connecting with and inviting known users, according to some embodiments; and

FIG. 3C illustrates a flowchart of a method for connecting with and inviting unknown users, according to some embodiments.

### DETAILED DESCRIPTION

The specific details of the single embodiment or variety of embodiments described herein are to the described system and methods of use. Any specific details of the embodiments are used for demonstration purposes only and not unnecessary limitations or inferences are to be understood therefrom.

No single embodiment includes features that are necessarily included in all embodiments, unless otherwise stated. Furthermore, although there may be references to “advantages” provided by some embodiments, other embodiments may not include those same advantages or may include different advantages. Any advantages described herein are not to be construed as limiting to any of the claims.

Before describing in detail exemplary embodiments, it is noted that the embodiments reside primarily in combinations of components related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second” and the like, may be used solely to distinguish one entity or element from another entity or element without necessarily requiring or implying any physical or logical relationship or order between such entities or elements.

In general, some embodiments herein provide for a system and method for securely updating and distributing information to third-parties. As used herein, the term “information” includes contact information (e.g., phone numbers, fax numbers, residence addresses, business addresses, mailing addresses, email addresses, company names, etc.), and personal information (e.g., birthdates, legal name changes, etc.). The system and method utilize distributed and encrypted data to transmit updated information to pre-authorized third-parties in a secure manner. This provides for seamless communication between users as information is continuously updated.

Once registered users authorize the transmission of updated information to and from one another, each user or party has a bi-directional relationship to facilitate the secure flow of information there between. Updates to information are automatically processed and sent to a list of approved third-parties. These updates are transmitted to the third-party, using public/private key encryption which is unique to each user (such as a public and private key system). Encrypted updated information is temporarily stored on the remote database until transmission to the third-party. Once the updated information is encrypted and transmitted to the system server, the third-party is notified of the update to the primary user's information.

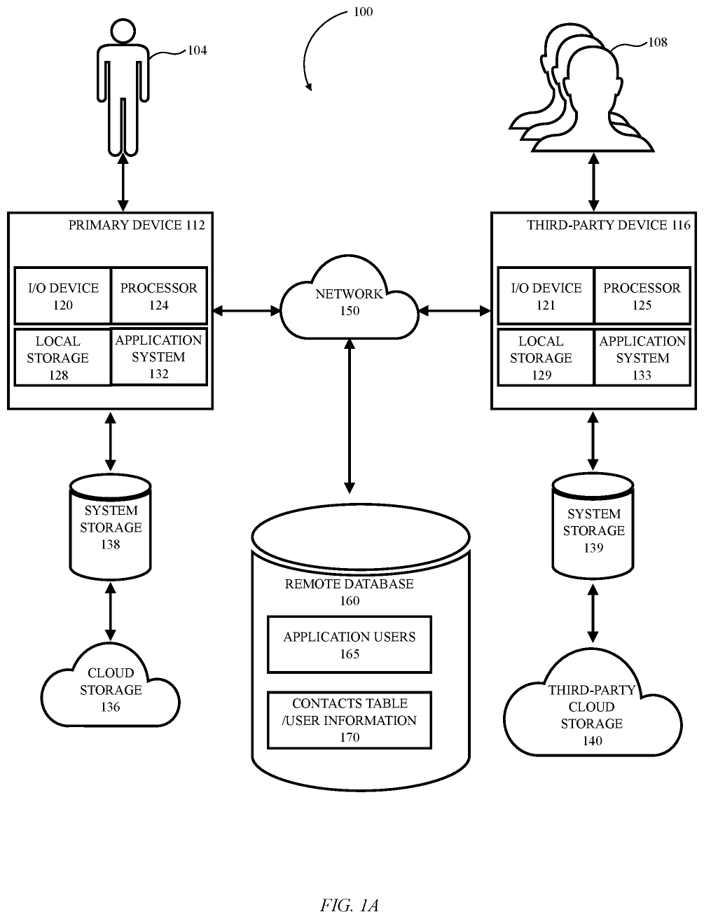

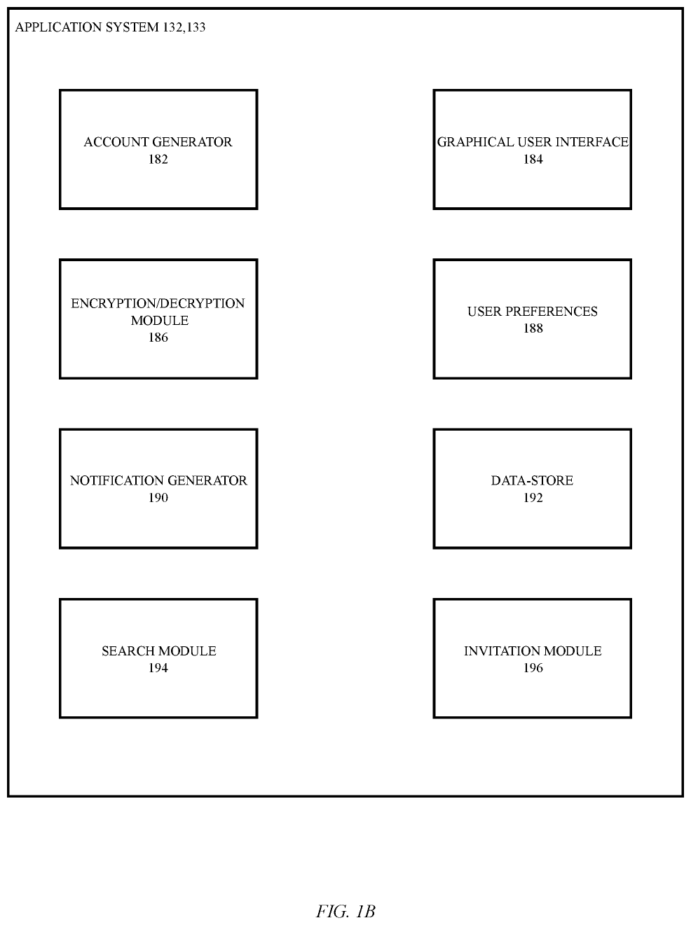

A “user,” as used herein, refers to an individual using a computer or similar computing device wherein a user will engage with a variety of information on applications, web pages, or information stored on the user's device. Now referring to FIG. 1A, as used herein, a user who modifies and/or makes changes to his/her user profile is referred to as the primary user 104. The computer system used to modify the primary user's profile is referred to herein as the primary device 112. The computer system that receives a notification on behalf of a third-party user 108 of the primary user's 104 updated information is referred to as the third-party device 116. The primary device 112 includes a first processor 124 and third-party devices 116 includes a second processor 125 wherein each processor is capable of processing direct user input/output (I/O) interactions. These systems include but are not limited to, desktop computers, laptop computers, personal digital assistants (PDAs), cell phones, tablets, etc.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be but is not limited to being, a process running on a processor, a processor, an object, an executable, a thread of execution, a program, and/or a computer. By way of illustration, both an application running on a server and the server can be a component. One or more components may reside within a process and/or thread of execution, and a component may be localized on one computer and/or distributed between two or more computers.

The local storage components 128, 129 each include volatile memory and nonvolatile memory. The I/O devices 120, 121 containing the basic routines to transfer information between elements within the device 112, 116 such as during start-up, is stored in nonvolatile memory. By way of example, and not limitation, nonvolatile memory can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory includes random access memory (RAM), which acts as external cache memory. By way of example and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM. Additionally, the disclosed storage components 128, 129 of systems or methods herein are intended to include, without being limited to including, these and any other suitable types of memory.

The primary device 112 and third-party device 116 can each include any device capable of processing user input/output from one or more I/O devices 120, 121 such as a touchscreen interface, keyboard, audio input component, video input component, or similar implement.

First, the primary user 104 downloads the first application system 132 and third-party user 108 must download the second application system 133 to their respective devices 112, 116.

The exchange of information between primary users 104 and third-party users 108 does not require that the users create, maintain, or store their information using the same or similar applications. Embodiments provide a distributed solution for automatically exchanging information such that the primary user 104 may manage a profile in communication with their local storage 128 and contact list. In other words, embodiments of the technology described herein allow information update events to be distributed directly to various third-parties of the application independent of the format used for the information. Updated information is sent via network 150. No peer-to-peer network is utilized for the sharing/updating of information. In this manner, contact information is not directly sent from primary device 112 to third-party device 116.

System storage component 138 stores contact information for the primary user 104 while system storage 139 stores contact information for the third-party users 108. Only the system storage 138, 139 can access the particular a user's 104, 108 cloud storage 136, 140.

FIG. 1B illustrates the first and second application system 132, 133 infrastructure in relation to some embodiments. An account generator 182 provides means for a user to create an account to utilize the system 100. When registering, each user provides essential information to the application system 132, 133 such as a phone number. The information input by the user is provided to the data-store 192, and a unique user-specific identifier (UID) can be provided to the user by the data-store 192. The UID can be a numeric, alphanumeric or alphabetical identifier, or any other suitable unique identifier such as a hash provided to the datastore 192. Once the user has elected to log in, the user may be prompted for necessary information that can include their phone number and passcode. The passcode can be provided via SMS messaging. Additional information can also be requested to verify the user's identity. The remote database 165 is queried to determine if the information submitted by the user is consistent with records maintained in the data-store 192.

The encryption/decryption module 186 provides, encrypts, and decrypts information using unique public keys, private keys, and hashing to each user 104, 108 having a profile on the system 100. The notification generator 190 generates notifications related to the exchange of information between users 104, 108 as further described below. In one embodiment, public key is stored in the cloud and backed up locally, while the private keys are stored locally on the users 104, 108 devices 112, 116 only.

In one embodiment, the applications systems 132, 133 each include user preferences 188. This can include known preferences in the arts including profile settings, notifications settings, interface settings, etc., as well as settings unique to the secure and selective transfer of information. In one example, once the user accesses his or her contact list, the user can have one or more options that can be performed in any desired order, which can vary from the order provided herein. Some of the general functions that the user can perform include editing and/or updating of the user's own information currently in the data-store 192. The user can also add new information related to one or more third-party users 108, and access information from one or more third-party users 108 within the contacts. Further, the user can view and/or edit the properties of the contacts, which can include assigning or changing a group for any third-party user 108, assigning or editing a clearance level for any third-party user 108, and/or adding or removing a third-party user 108 to or from the user's third-party user 108 list.

In another embodiment, the user can select a privacy level for one or more information fields. In general, the privacy level is used in conjunction with a clearance level that the user can assign to each third-party user 108 to customize which information fields of the user each third-party user 108 in the user's contact list will be able to receive when updated.

In one embodiment, third-party users 108 can be assigned a group. For example, the user can select from predetermined groups such as “Business, “Friends,” “Family,” “All,” “Special,” etc., or the user can customize the name of the group, e.g., “Gym.” The user can specify a group setting for one or more third-party users 108 in the user's contact list such that user-determined third-party users 108 are temporarily or permanently excluded from the list. In this manner, only user-determined third-party user 108 will receive updated information.

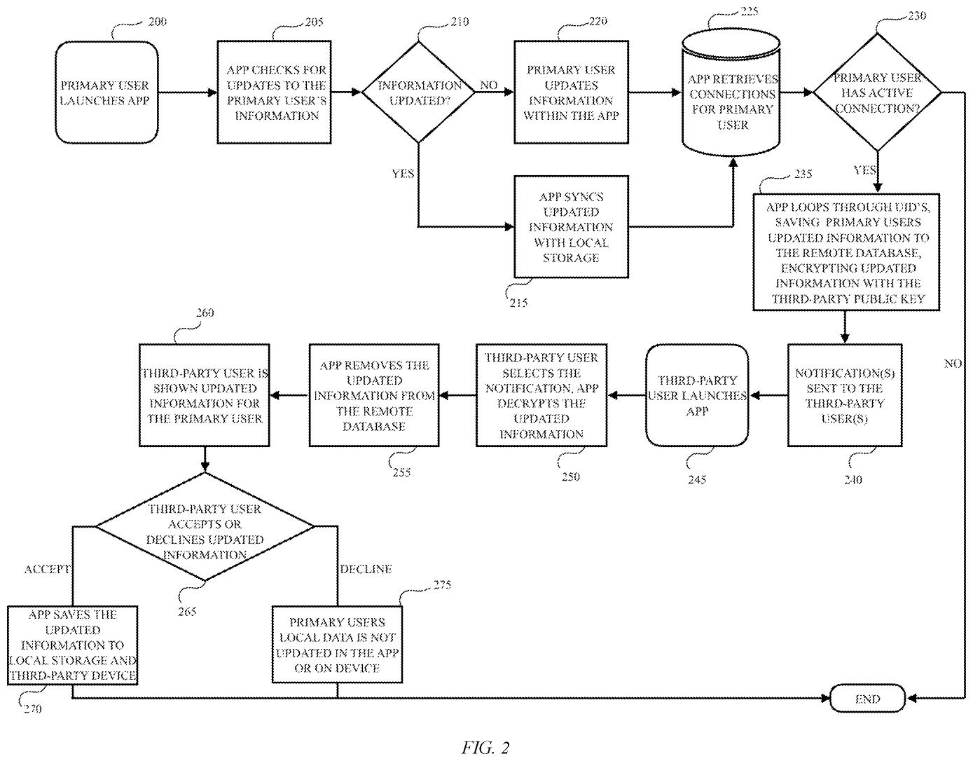

In reference to FIG. 2, a method is provided for updating information across a network 150. In step 200, the primary user 104 launches the first application system 132 on his/her device 112. The first applications system checks for any updates to the primary user's 104 information, by consulting contact records or sources of information stored on the system storage component 138. If information was updated (box 210), the first application system 132 syncs the updated information with the local storage component 128 in step 215. If no information has been updated, the primary user 104 may update his or her information within the application system GUI 184. In step 225, the application system retrieves, via a remote database 160 containing application users (e.g., UID's) 165 and public keys for all active third-party users 108 who correspond with the primary user 104. This correspondence between the primary user 104 and third-party users 108 can include all contacts in the primary user's local storage 128, system storage 138, 139 and/or cloud storage 136, 140. In box 230, if the primary user 104 does not have active third-party users 108 in connection, no additional steps are taken while if the primary user 104 does have active third-party users 108, the first application system 132 loops through each returned user identification (UID) and saves the primary user's 104 updated information into the remote database 160. Before transmission to the remote database 160, the information is encrypted via each third-party user's 108 unique public key in step 235.

In step 240, once the information is encrypted and briefly stored in the remote database 160, third-party users 108 are notified of the updated information for the specific primary user 104. In one example, the information is stored for a period of 10 days. Following this period of time, the information is replaced with a missed updated notification. Once the notification, which can be sent via push/alert notifications, is sent, in step 245 each third-party user 108 launches the second application system 133 on their specific third-party device 116. In step 250, each third-party user 108 selects, via the second application system 133 GUI 184, the updated information to cause the second application system 133 to decrypt the information using the third-party user's 108 private key. Once decrypted, the information is removed from the remote database 160 in step 255. In step 260, the decrypted updated information is provided to the third-party user 108 such that they can manually accept, decline, or automatically accept the updated information. In step 270, if the third-party user 108 manually accepts or automatically accepts the update, the second application system 133 saves the updated information to its local storage 129, and the third-party device's 116 system storage 139. If the third-party user 108 declines the update, no information is updated as shown in step 275.

In one embodiment, the user may select particular contacts (based on the retrieved contact information) to receive specific updated information. In an example, the primary user 104 can pre-define parameters for update information to be sent automatically to all contacts or a group of contacts in the user's address book or contact list. The updated information can then be distributed via the methods described above to the selected or pre-defined third-party users 108.

Similarly, it is to be appreciated that in accordance with one or more embodiments, users can opt-out of providing or receiving personal information, location information, proprietary information, sensitive information, or the like in connection with information gathering aspects. Moreover, one or more implementations described herein can provide for anonymizing collected, received, or transmitted data.

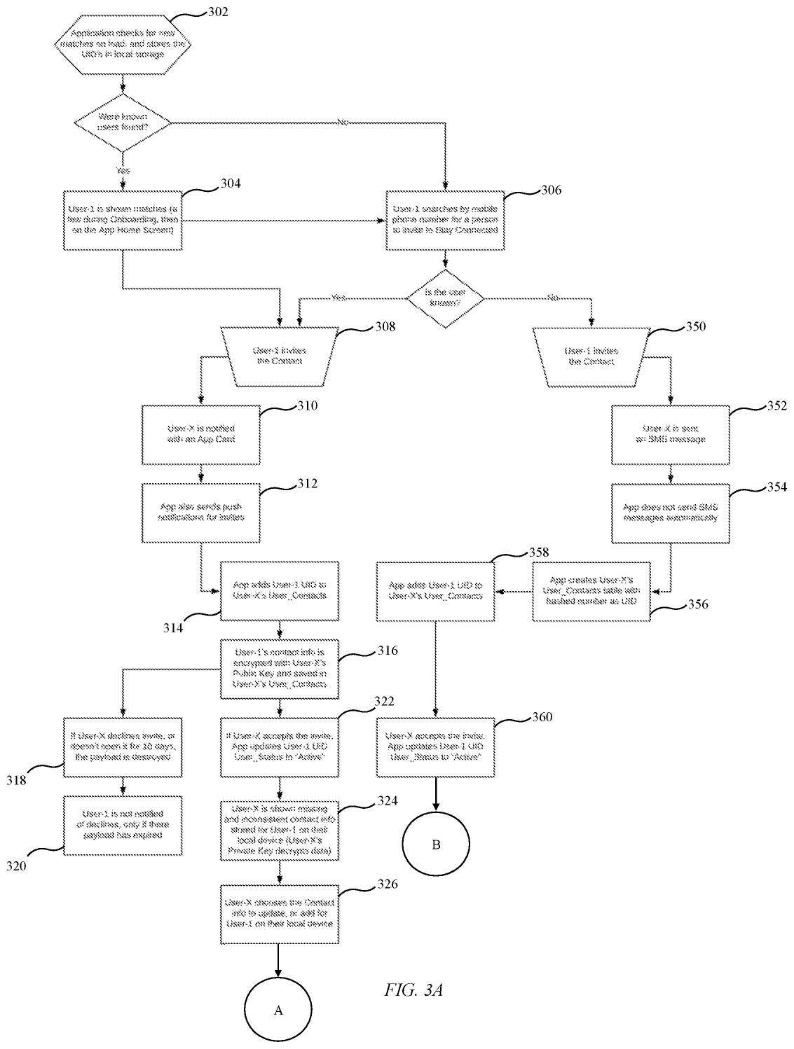

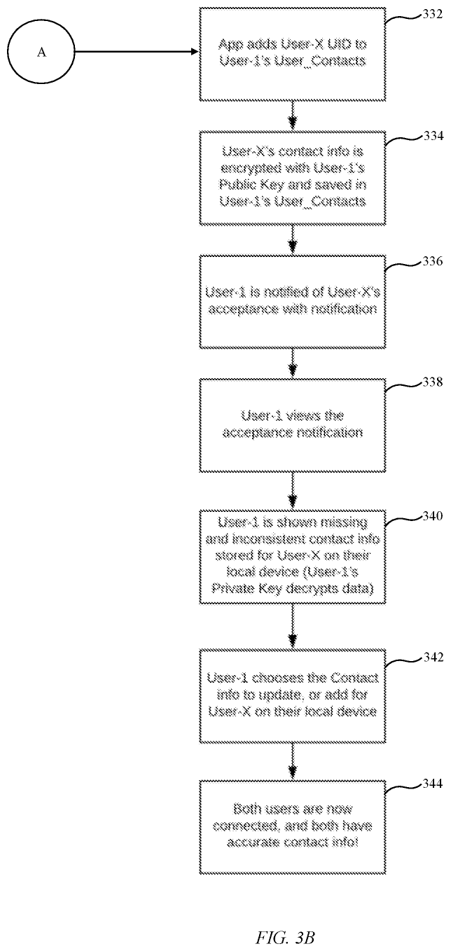

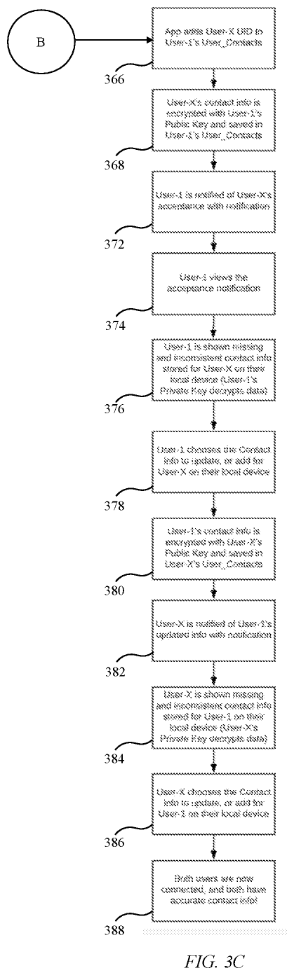

FIGS. 3A-3C illustrates a method for inviting and connecting with users within the system 100 wherein “User-1” refers to the primary user 104 and “User-X” refers to the third-party user 108. At step 302 the application system checks for new matched connections and stores them in local storage 128. If new connections were found, the primary user is shown the matched connections in step 304. If no connection were found, the user can search, using the search module 194 see (FIG. 1B) in step 306. If the searched connection is known in the system, the primary user 104 invites the third-party user 108 in step 308. If the user is unknown, the primary user 104 invites the third-party user 108 in step 350.

In steps 310 and 312, the third-party user 108 is notified and the application system sends the primary user's 104 UID and information to the third-party users 108 contacts table 170 in step 314. In step 314, the primary user's 104 UID is saved in the third-party user's 108 contacts table 170. In step 316, the application system will use the third-party users 108 public key to encrypt the stored information in the third-party user's contacts table 170. In step 318, if the third-party user 108 declines the invite or does not interact with the invite for a period of time, the information is destroyed. In step 320 the primary user 104 is not notified of a decline, however, they may be sent a notification to re-invite the user when the information has expired. The application system decrypts the encrypted information using the third-party user's 108 private key. Once the third-party user 108 accepts the invite in step 322, the third-party user 108 is shown missing and inconsistent information related to the primary user 104 in step 324. In step 326, the third-party user 108 selects the information to sync on the third-party device 116 related to the primary user 104. Following the selection, the application system adds the third-party users 108 UID to the primary user's 104 contacts record in the remote storage 160, step 332. In step 334, the correct information for the third-party user 108 is first encrypted using the primary user's 104 public key. The information is saved in the primary user's 104 contacts record in the remote storage 160. In step 336, the primary user is notified of the third-party user's 108 acceptance with a notification. In steps 338 and 340, as the primary user views the acceptance notification, the applications system uses the primary users 104 private key to decrypt the encrypted information. The primary user is shown missing and inconsistent information stored for the third-party user 108 on their system storage 138. In step 342, the primary user 104 selects the information, related to the third-party user 108, they wish to update and sync on the primary device 112. In step 344, both the primary user 104 and third-party user 108 have access to each other's updated contact information.

In step 350, wherein the user is unknown in the system following the search, the third-party user 108 is notified via SMS messaging in step 352 which may not be sent automatically (step 354). In step 356, the applications system creates the third-party users 108 contact table with a hashed UID. In step 358, the applications system adds the primary user's 104 UID to the third-party user's 108 contacts table 170 in remote database 160 and in step 360, the invite is accepted by the third-party user 108 resulting in the application system updating the primary user's 104 status to active. In step 366, the applications system adds the third-party users 108 UID to the primary user's 104 contacts table 170. In step 368, correct information for the third-party user 108 is saved in the primary user's 104 contacts table 170 and the third-party information is encrypted via the primary user's 104 public key. In step 372, the primary user 104 is notified of the third-party users 108 acceptance, and the primary user views the acceptance notification in step 374. In step 376, the primary user 104 is shown missing or inconsistent information related to the third-party user 108. This information is decrypted by the private key of the primary user 104. In steps 378, the primary user 104 selects the third-party user 108 information to be updated on the primary device which is then saved in system storage 138. The application uses the third-party users 108 public key to encrypt information in step 380 and the third-party user is notified of the primary user's 104 updated information in step 382. In step 384, the third-party user 108 is shown the missing and inconsistent information which is decrypted by the third-party users 108 private key. In steps 386 and 388 the third-party user 108 then selects information they wish to update on the third-party device 116, such that each user 104, 108 has access to each other's information.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A secure information exchange system comprising:
a plurality of users including a primary user in communication with a primary device, the primary user in network communication with a plurality of third-party users each in communication with a third-party device, the primary device including a local storage component configured to store a plurality of information, the third-party device including a second local storage configured to store the plurality of information; and
a first application system stored on the primary device and a second application system stored on the third-party device, the first application system being operable, via a first processor, to transmit a plurality of encrypted information to a remote server, the second application system being operable, via a second processor, to receive and decrypt the encrypted information.

2. The system of claim 1, wherein information sent from the primary device to the third-party device is encrypted at the primary device, and decrypted at the third-party device using a private key.

3. The system of claim 2, wherein each user has a unique public key and a unique private key.

4. The system of claim 1, wherein the first application system includes a notification generator to monitor information updates provided by the primary user and transmit notifications to at least one of the plurality of third-party users upon the update of information.

5. The system of claim 4, wherein the third-party user is provided the option via a second application system to accept or decline an information update.

6. The system of claim 5, wherein the accepted information update causes the application system to save the information update to the storage component.

7. The system of claim 1, wherein the primary user provides a privacy level for at least one information field.

8. The system of claim 7, wherein the primary user provides a clearance level to at least one of the plurality of third-party users.

9. The system of claim 8, wherein the privacy level corresponds to the clearance level.

10. A secure information exchange system comprising:
a plurality of users including a primary user in communication with a primary device, the primary user in network communication with a plurality of third-party users each in communication with a third-party device, the primary device including a storage component configured to store a plurality of information, the third-party device including a second local storage configured to store a plurality of information; and
a first application system stored on the primary device and a second application system stored on the third-party device, the first application system being operable, via a first processor, to encrypt primary user information using a public key and transmit the encrypted primary user information to a remote database, the second applications system, being operable via a second processor receives the encrypted information from the remote database, and decrypts the encrypted information received by the third-party user, the decrypted information is stored on the second local storage component.

11. The system of claim 10, comprising the steps of:
verifying, via the first application system, a plurality of information provided on a local storage component in communication with the primary device;
updating, via the primary user, information using the first application system;
identifying, via the first application system, a plurality of third-party user identifications;
encrypting, via a third-party public key, the updated information;
transmitting, via the first applications system, the encrypted updated information to a remote database;
transmitting, via the first application system, a notification generated by the second application system of updated information to least one of the third-party users;
removing, via the second application system, the encrypted updated information from the remote server;
decrypting, via the third-party private key on the third-party device, the encrypted updated; and
storing, the decrypted updated information at the third-party device.

12. The system of claim 10, wherein information is encrypted and decrypted using a public/private key.

13. The system of claim 12, wherein the public/private key is unique to each of the plurality of users.

14. The system of claim 10, wherein the remote database stores a hashed user identification for the primary user and the plurality of third-party users.

15. The system of claim 10, wherein the primary user provides a privacy level for at least one information field.

16. The system of claim 15, wherein the primary user provides a clearance level to at least one of the plurality of third-party users.

17. The system of claim 16, wherein the privacy level corresponds to the clearance level.

18. A method for securely exchanging information, the method comprising:
verifying, via the first application system, a plurality of information provided on a local storage component in communication with the primary device;
updating, via the primary user, information using the first application system;
identifying, via the first application system, a plurality of third-party user identifications;
encrypting, via a third-party public key, the updated information;
transmitting, via the first applications system, the encrypted updated information to a remote database;
transmitting, via the first application system, a notification generated by the second application system of updated information to least one of the third-party users;
removing, via the second application system, the encrypted updated information from the remote server;
decrypting, via the third-party private key on the third-party device, the encrypted updated; and
storing, the decrypted updated information at the third-party device.

19. The method of claim 18, further comprising the step of the plurality of third-party users accepting, declining, or automatically accepting the decrypted updated information.

20. The method of claim 19, wherein declining the decrypted updated information deletes the information update.
